(19) United States
(12) Patent Application Publication
(10) Pub. No.: US 2016/0320681 A1
(43) Pub. Date: Nov. 3, 2016

(54) DISPLAY DEVICE

(71) Applicant: SAMSUNG DISPLAY CO., LTD., Yongin-si (KR)

(72) Inventors: Kyunho Kim, Cheonan-si (KR); Sungin Kang, Hwaseong-si (KR); Jieun Jang, Cheonan-si (KR); Shimho Yi, Seoul (KR)

(21) Appl. No.: 14/977,193

(22) Filed: Dec. 21, 2015

(30) Foreign Application Priority Data
Apr. 30, 2015 (KR) 10-2015-0061131

(51) Int. Cl. G02F 1/1362; G09G 3/36

(52) U.S. Cl. CPC G02F 1/136204; G09G 3/3677; G09G 2300/0809; G09G 2310/0286; G09G 2310/0291; G09G 2330/04

(57) ABSTRACT

A display device includes: a gate driver configured to drive a plurality of gate lines of a display panel; at least one control line configured to transmit at least one control signal to the gate driver; a first static-electricity prevention unit on the display panel, the first static-electricity prevention unit being connected to the at least one control line; and a second static-electricity prevention unit outside the display panel, the second static-electricity prevention unit connected between the first static-electricity prevention unit and ground.

### CROSS-REFERENCE TO RELATED APPLICATION

This application claims priority to and the benefit of Korean Patent Application No. 10-2015-0061131, filed on Apr. 30, 2015, with the Korean Intellectual Property Office (KIPO), the disclosure of which is incorporated herein in its entirety by reference.

### BACKGROUND

1. Field

Aspects of embodiments of the present invention relate to a display device, and more particularly, to a display device capable of significantly reducing damage incurred to a component due to static electricity and reducing manufacturing cost thereof.

2. Description of the Related Art

Liquid crystal display (“LCD”) devices commonly include a lower substrate including a pixel electrode, a pixel transistor, and so forth disposed thereon, an upper substrate including a color filter and a common electrode disposed thereon, and a liquid crystal layer between the lower substrate and the upper substrate. Herein, upon applying voltages respectively to the lower substrate and the upper substrate (e.g., applying a voltage differential across the lower substrate and the upper substrate), a liquid crystal may be operated and a level of light transmittance may be adjusted, such that the LCD device may display an image.

A glass substrate may be used as the lower substrate and the upper substrate of the LCD device. Because the glass substrate is an insulator, which is different from (e.g., a different material from) a silicon wafer, an issue of static electricity caused in a manufacturing process is critical compared to that in a comparative semiconductor manufacturing process. For example, during the manufacturing process, a spin dry process may cause static electricity (e.g., static charge) to be caused, generated, or formed onto the glass substrate due to friction with air. In a case where a portion of the glass substrate is electrificated (or electrified) by the static electricity induced during the manufacturing process, dust and the like may be easily attached thereto due to electrostatic force, which leads to a process defect. In addition, the pixel transistor of the lower substrate is extremely vulnerable to the static electricity, and thus may be easily damaged when the static electricity externally flows thereto via a signal input.

Further, a control line for transmitting a clock signal and the like for driving a gate driver may commonly include metal, and thus may serve as an antenna with respect to static electricity generated in the manufacturing process of the LCD device. Because the manufacturing process of the LCD device is largely performed on the glass substrate, which is a non-conductor, instantaneously generated electric charges may not be dispersed downwardly of the substrate (e.g., the charge may not be discharged through the substrate) and may be concentrated on the control line. Accordingly, an insulating layer or the pixel transistor of the lower substrate may be damaged due to static electricity surge through the control line. Further, the static electricity may flow into the gate driver through the control line to damage the gate driver.

It is to be understood that this background of the technology section is intended to provide useful background for understanding the technology and as such disclosed herein, the technology background section may include ideas, concepts or recognitions that were not part of what was known or appreciated by those skilled in the pertinent art prior to a corresponding effective filing date of subject matter disclosed herein.

### SUMMARY

Aspects of embodiments of the present invention are directed to a display device which includes a static-electricity prevention unit capable of outwardly discharging static electricity having flown into a control line and is reduced in a manufacturing cost by disposing the static-electricity prevention unit in an efficient manner.

According to an exemplary embodiment, a display device includes: a gate driver configured to drive a plurality of gate lines of a display panel; at least one control line configured to transmit at least one control signal to the gate driver; a first static-electricity prevention unit on the display panel, the first static-electricity prevention unit being connected to the at least one control line; and a second static-electricity prevention unit outside the display panel, the second static-electricity prevention unit connected between the first static-electricity prevention unit and ground.

The first static-electricity prevention unit may include at least one pattern-type static-electricity prevention element connected to the at least one control line, and the second static-electricity prevention unit may include at least one mount-type static-electricity prevention element connected between the at least one pattern-type static-electricity prevention element and ground.

The number of the pattern-type static-electricity prevention elements may be greater than the number of mount-type static-electricity prevention elements.

The pattern-type static-electricity prevention element may include: a first pattern-type Zener diode connected to the control line; and a second pattern-type Zener diode connected between the first pattern-type Zener diode and the second static-electricity prevention unit.

Each of the first pattern-type Zener diode and the second pattern-type Zener diode may be a transistor having a shape of diode.

The first pattern-type Zener diode and the second pattern-type Zener diode may be connected to each other in a reverse manner.

The mount-type static-electricity prevention element may include: a first Zener diode connected to the first static-electricity prevention unit; and a second Zener diode connected between the first Zener diode and ground.

The first Zener diode and the second Zener diode may be connected to each other in a reverse manner.

The first static-electricity prevention unit may be formed concurrently with a pixel transistor of the display panel.

The display device may further include a circuit board connected to the display panel, the second static-electricity prevention unit being located on the circuit board.

The second static-electricity prevention unit may be detachably connected to the circuit board.

The display device may further include a carrier connected between the circuit board and the display panel and connecting the first static-electricity prevention unit and the second static-electricity prevention unit.

The display device may further include a common voltage line connected to a node between the first static-electricity prevention unit and the second static-electricity prevention unit.

The common voltage line may be located on the display panel and connected to a common electrode of the display panel.

The display device may further include a storage voltage line connected to the node between the first static-electricity prevention unit and the second static-electricity prevention unit.

The storage voltage line may be located along a side of the pixel electrode of the display panel.

The display device may further include an off-voltage line connected to the node between the first static-electricity prevention unit and the second static-electricity prevention unit.

The off-voltage line may be configured to apply an off voltage to the gate driver.

The node between the first static-electricity prevention unit and the second static-electricity prevention unit may be located on the display panel.

The foregoing is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The above and other features and aspects of the present disclosure of invention will be more clearly understood from the following detailed description taken in conjunction with the accompanying drawings, in which:

FIG. 1 is a plan view illustrating a display device according to an exemplary embodiment of the present invention;

FIG. 2 is a detailed configuration view illustrating a pixel of FIG. 1 according to one embodiment of the present invention;

FIG. 3 is a block diagram illustrating a gate driver of FIG. 1 according to one embodiment of the present invention;

FIG. 4 is a circuit diagram illustrating a first stage of FIG. 3 according to one embodiment of the present invention;

FIG. 5 is a detailed configuration view illustrating an example of first, second, and third pattern-type static-electricity prevention elements and a mount-type static-electricity prevention element of FIG. 3 according to one embodiment of the present invention;

FIG. 6 is a detailed configuration view illustrating another example of first, second, and third pattern-type static-electricity prevention elements and a mount-type static-electricity prevention element of FIG. 3 according to one embodiment of the present invention; and

FIG. 7 is a plan view illustrating a display device according to another exemplary embodiment of the present invention.

### DETAILED DESCRIPTION

Aspects and features of the present invention and methods for achieving them will be made clear from exemplary embodiments described below in more detail with reference to the accompanying drawings. The present invention may, however, be embodied in many different forms and should not be construed as being limited to the exemplary embodiments set forth herein. Rather, these exemplary embodiments are provided so that this disclosure will be thorough and complete, and will fully convey the scope of the invention to those skilled in the art. The present invention is merely defined by the scope of the claims and equivalents thereof. Therefore, well-known constituent elements, operations, and techniques are not described in more detail in the exemplary embodiments in order to prevent the present invention from being obscurely. Like reference numerals refer to like elements throughout the specification.

In the drawings, areas are illustrated in an enlarged manner for clarity and ease of description thereof. When a layer, area, or plate is referred to as being “on” another layer, area, or plate, it may be directly on the other layer, area, or plate, or intervening layers, areas, or plates may be present therebetween. Conversely, when a layer, area, or plate is referred to as being “directly on” another layer, area, or plate, intervening layers, areas, or plates may be absent therebetween. Further when a layer, area, or plate is referred to as being “below” another layer, area, or plate, it may be directly below the other layer, area, or plate, or intervening layers, areas, or plates may be present therebetween. Conversely, when a layer, area, or plate is referred to as being “directly below” another layer, area, or plate, intervening layers, areas, or plates may be absent therebetween.

The spatially relative terms “below”, “beneath”, “lower”, “above”, “upper”, and the like, may be used herein for ease of description to describe the relations between one element or component and another element or component as illustrated in the drawings. It will be understood that the spatially relative terms are intended to encompass different orientations of the device in use or operation, in addition to the orientation depicted in the drawings. For example, in the case where a device shown in the drawing is turned over, the device positioned (or located) “below” or “beneath” another device may be placed “above” another device. Accordingly, the illustrative term “below” may include both the lower and upper positions. The device may also be oriented in the other direction, and thus the spatially relative terms may be interpreted differently depending on the orientations.

Throughout the specification, when an element is referred to as being “connected” to another element, the element is “directly connected” to the other element, or “electrically connected” to the other element with one or more intervening elements interposed therebetween. It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

It will be understood that, although the terms “first,” “second,” “third,” and the like may be used herein to describe various elements, these elements should not be limited by these terms. These terms are only used to distinguish one element from another element. Thus, “a first element” discussed below could be termed “a second element” or “a third element,” and “a second element” and “a third element” can be termed likewise without departing from the teachings herein.

Unless otherwise defined, all terms used herein (including technical and scientific terms) have the same meaning as commonly understood by those skilled in the art to which this invention pertains. It will be further understood that terms, such as those defined in commonly used dictionaries, should be interpreted as having a meaning that is consistent with their meaning in the context of the relevant art and will not be interpreted in an ideal or excessively formal sense unless clearly defined in the present specification.

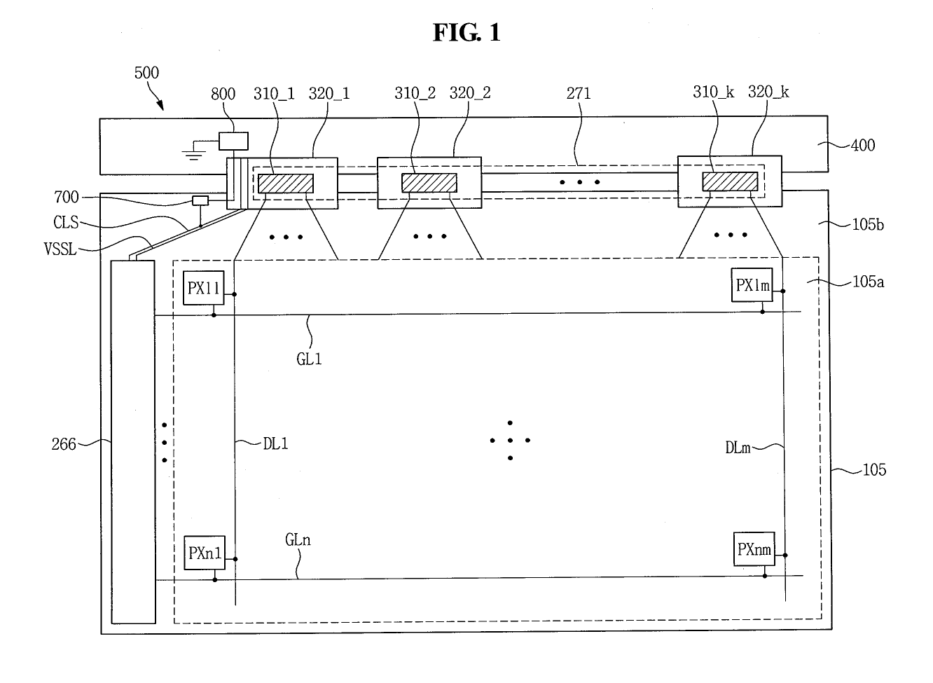

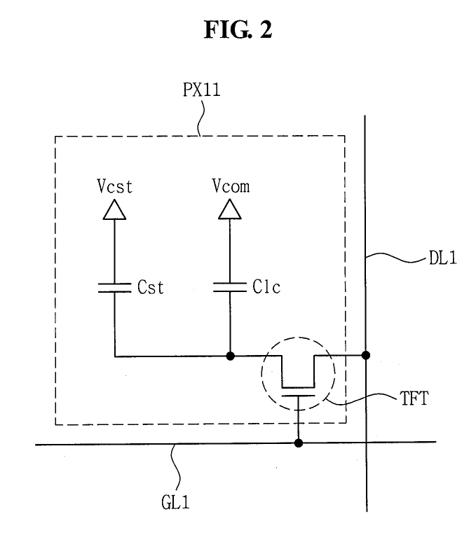

FIG. 1 is a plan view illustrating a display device according to an exemplary embodiment of the present invention, and FIG. 2 is a detailed configuration view illustrating a pixel of FIG. 1.

A liquid crystal display (LCD) device 500 according to the exemplary embodiment may include a display panel 105, a gate driver 266, a data driver 271, and a driving circuit board 400.

The display panel 105 may include a display area 105a in which a plurality of pixels PX11-PXnm arranged in a matrix form are disposed, a non-display area 105b surrounding the display area 105a, a plurality of gate lines GL1-GLn, a plurality of data lines DL1-DLm crossing the plurality of gate lines GL1-GLn, a control signal transmission unit CLS, and an off-voltage line VSSL.

The gate lines GL1-GLn may be connected to the gate driver 266. The gate lines GL1-GLn may receive an input of gate signals sequentially applied thereto, the gate signals being sequentially generated from the gate driver 266.

The data lines DL1-DLm may be connected to the data driver 271. The data lines DL1-DLm may receive an input of data voltages in an analog form applied thereto from the data driver 271.

The pixels PX11-PXnm may be positioned (or located) in an area in which the gate lines GL1-GLn and the data lines DL1-DLm cross one another. The pixels PX11-PXnm may be arranged in “m” number of columns and “n” number of rows, the columns and rows crossing one another. “m” and “n” may be integers greater than zero.

The pixels PX11-PXnm may be connected to the gate lines GL1-GLn and the data lines DL1-DLm, respectively, in a corresponding manner (e.g., pixel PXij may be connected to gate line GLi and data line DLj). The pixel may receive the data voltage supplied thereto from the data line, in response to the gate signal from the gate line. The pixel may emit light at a gray level (or a gray scale level) corresponding to the data voltage.

The pixels PX11-PXnm may each have a configuration as illustrated in FIG. 2. Because all the pixels PX11-PXnm have the same configuration, one of the pixels PX11 connected to the first gate line GL1 and the first data line DL1 will be representatively described herein.

The pixel PX11, as illustrated in FIG. 2, may include a thin film transistor TFT, a liquid crystal capacitor Clc, and a storage capacitor Cst.

The thin film transistor TFT may be turned on based on a gate signal applied from the gate line GL1. The turned-on transistor TFT may apply an analog image data signal applied from the data line DL1 to the liquid crystal capacitor Clc and the storage capacitor Cst.

The thin film transistor TFT may include a semiconductor layer, a gate electrode, a drain electrode, and a source electrode. The gate electrode of the thin film transistor TFT may overlap the semiconductor layer to be connected to the gate line GL1. The drain electrode of the thin film transistor TFT may overlap the gate electrode to be connected to the data line. The source electrode of the thin film transistor TFT may overlap the semiconductor layer and the gate electrode to be connected to a pixel electrode.

The liquid crystal capacitor Clc may include the pixel electrode and a common electrode disposed to oppose each other.

The storage capacitor Cst may include a pixel electrode and an opposing electrode disposed to oppose each other. Herein, the opposing electrode may be one of a previous gate line (e.g., a gate line corresponding to a previous or lower numbered row of pixels), a common line which may transmit a common voltage, and a storage line which may transmit a storage voltage.

The control signal transmission unit CLS may be connected to the gate driver 266 through a leftmost carrier 320_1. The control signal transmission unit CLS may receive control signals from a timing controller which is mounted on the driving circuit board 400. The control signals may be supplied to the gate driver 266 through the control signal transmission unit CLS. The off-voltage line VSSL may be connected to the gate driver 266 through the leftmost carrier 320_1. The off-voltage line VSSL may receive an off-voltage from a power generator which is mounted on the driving circuit board 400. The off-voltage may be supplied to the gate driver 266 through the off-voltage line VSSL.

The gate driver 266 may be disposed in a portion of the non-display area 105b adjacent to a side of the display area 105a. In more detail, the gate driver 266 may be mounted on a portion of the non-display area 105b adjacent to a left side of the display area 105a. The gate driver 266 may sequentially generate the gate signals using the control signals supplied through the control signal transmission unit CLS, and may supply the generated gate signals to the gate lines GL1-GLn. The gate lines GL1-GLn may be sequentially driven from an uppermost gate line (e.g., GL1) to a lowermost gate line (e.g. GLn).

The data driver 271 may receive data signals supplied thereto from the timing controller, and may generate analog data voltages corresponding to the supplied data signals. The data driver 271 may supply data voltages to the pixels PX11-PXnm through the data lines DL1-DLm. The data driver 271 may include a plurality of source driving chips 310_1-310_k, where “k” is an integer greater than zero and less than “m”. The source driving chips 310_1-310_k may be mounted on corresponding carriers 320_1-320_k. The source driving chips 310_1-310_k may be connected between the driving circuit board 400 and a portion of the non-display area 105b adjacent to an upper portion of the display area 105a. The carriers 320_1-320_k may each be a flexible printed circuit board.

In addition, the source driving chips 310_1-310_k may be mounted on the portion of the non-display area 105b adjacent to the upper portion of the display area 105a, in a chip-on-glass (COG) manner.

A first static-electricity prevention unit 700 may be disposed on the display panel 105. For example, the first static-electricity prevention unit 700 may be disposed in the non-display area 105b of the display panel 105. The first static-electricity prevention unit 700 may be connected to the control signal transmission unit CLS. The first static-electricity prevention unit 700 may be concurrently (e.g., simultaneously) manufactured along with the pixel transistor TFT of the display panel 105. For example, the first static-electricity prevention unit 700 and the pixel transistor TFT may be manufactured through the same photolithography and etching process.

A second static-electricity prevention unit 800 may be disposed outside the display panel 105. For example, the second static-electricity prevention unit 800 may be mounted on the driving circuit board 400. The second static-electricity prevention unit 800 may be connected between the first static-electricity prevention unit 700 and ground. The second static-electricity prevention unit 800 may be detachably connected to the driving circuit board 400. Ground may be positioned (or located) on the driving circuit board 400.

The first static-electricity prevention unit 700 may be connected to the second static-electricity prevention unit 800 through the leftmost carrier 320_1.

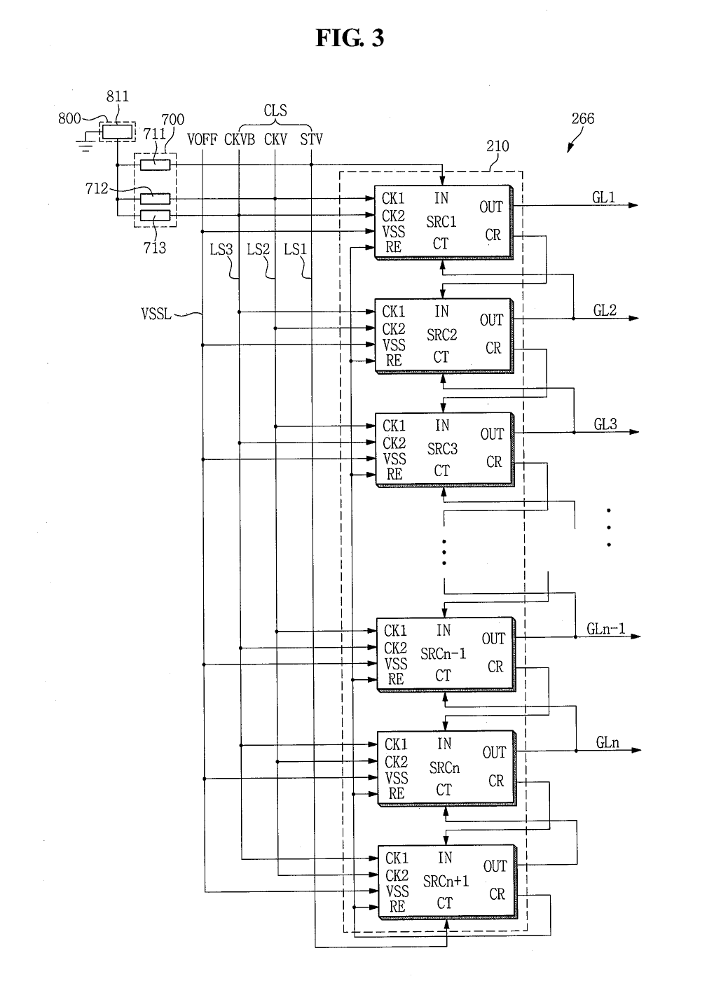

FIG. 3 is a block diagram illustrating the gate driver 266 illustrated in FIG. 1.

The gate driver 266, as illustrated in FIG. 3, may include a shift register 210. The shift register 210 may include first through (n+1)^{th} stages SRC1-SRCn+1 which are dependently connected. The first through n-th stages SRC1-SRCn may be defined as (or referred to as) a driving stage, and the (n+1)^{th} stage SRCn+1 may be defined as (or referred to as) a dummy stage. The first through n-th stages SRC1-SRCn may be connected to first through n-th gate lines GL1, . . . , GLn. The first through n-th stages SRC1-SRCn may sequentially output first through n-th gate signals to the first through n-th gate lines GL1, . . . , GLn (e.g., respectively).

The first through (n+1)^{th} stages SRC1-SRCn+1 may each include a first clock terminal CK1, a second clock terminal CK2, an off-voltage terminal VSS, a reset terminal RE, a control terminal CT, a carry terminal CR, an output terminal OUT, and an input terminal IN.

The first clock terminal CK1 and the second clock terminal CK2 may receive an input of clock signals applied thereto, the clock signals having opposite phases from each other. For example, because a first clock signal CKV is input to the first clock terminal CK1 of each of odd-numbered stages SRC1, SRC3, . . . , SRCn−1 (assuming n is an even number), and a second clock signal CKVB is input to the second clock terminal CK2 of each of the odd-numbered stages SRC1, SRC3, . . . , SRCn−1, the second clock signal CKVB may have a phase shifted by 180 degrees with respect to a phase of the first clock signal CKV. Conversely, the second clock signal CKVB may be input to the first clock terminal CK1 of each of even-numbered stages SRC2, SRC4, . . . , SRCn, and the first clock signal CKV may be input to the second clock terminal CK2 of each of the even-numbered stages SRC2, SRC4, . . . , SRCn.

The input terminal IN of the first stage SRC1 and the control terminal CT of the dummy stage SRCn+1 may receive an input of a vertical start signal STV applied thereto. The input terminals IN of the second through (n+1)^{th} stages SRC2-SRCn+1 may each receive an input of a carry signal applied thereto, the carry signal being output from the carry terminal CR of each previous stage. The carry signal output from the carry terminal CR may serve to drive a subsequent stage. The control terminals CT of the first through n-th stages SRC1-SRCn may each receive an input of a gate signal applied thereto, the gate signal being output from the output terminal OUT of each subsequent stage. An off-voltage VOFF (or ground voltage) may be input to the off-voltage terminals VSS of the first through (n+1)^{th} stages SRC1-SRCn+1. The reset terminals RE of the first through (n+1)^{th} stages SRC1-SRCn+1 may receive a carry signal applied thereto as a common signal, the carry signal being output from the carry terminal CR of the dummy stage SRCn+1.

The first and second clock signals CKV and CKVB may be a gate-on-voltage capable of driving a pixel in a case of having a high level, and may be a gate-off-voltage in a case of having a low level. The output terminals OUT of the first through (n+1)^{th} stages SRC1-SRCn+1 may output a high level period of a clock signal supplied to the first clock terminal CK1. For example, the output terminals OUT of the odd-numbered stages SRC1, SRC3, . . . , SRCn−1 may output a high level period of the first clock signal CKV, and the output terminals OUT of the even-numbered stage SRC2, SRC4, . . . , SRCn may output a high level period of the second clock signal CKVB. The carry terminals CR of the first through (n+1)^{th} stages SRC1-SRCn+1 may output a carry signal based on a clock signal the same as the clock signal output from the output terminal OUT.

The off-voltage line VSSL may be connected to the off-voltage terminals VSS of the first through (n+1)^{th} stages SRC1-SRCn+1. The off-voltage line VSSL may transmit an off-voltage VOFF. The control signal transmission unit CLS may include a first control line LS1 that receives a vertical start signal SW, a second control line LS2 that receives a first clock signal CKV, a third control line LS3 that receives a second clock signal CKVB.

The first control line LS1 may be electrically connected to the input terminal IN of the first stage SRC1 and the control terminal CT of the dummy stage SRCn−1. The first control line LS1 may transmit a vertical start signal SW.

The second control line LS2 may be connected to the first clock terminals CK1 of the odd-numbered stages SRC1, SRC3, . . . , SRCn−1 and the second clock terminals CK2 of the even-numbered stages SRC2, SRC4, . . . , SRCn. The second control line LS2 may transmit a first clock signal CKV.

The third control line LS3 may be connected to the first clock terminals CK1 of the even-numbered stages SRC2, SRC4, . . . , SRCn and the second clock terminals CK2 of the odd-numbered stages SRC1, SRC3, . . . , SRCn−1. The third control line LS3 may transmit a second clock signal CKVB.

The first static-electricity prevention unit 700 may include at least one pattern-type static-electricity prevention element, and in FIG. 3, the first static-electricity prevention unit 700 including three pattern-type static-electricity prevention elements 711, 712, and 713 is illustrated by way of example. Herein, the three pattern-type static-electricity prevention elements 711, 712, and 713 may be defined as a first pattern-type static-electricity prevention element 711, a second pattern-type static-electricity prevention element 712, and a third pattern-type static-electricity prevention element 713, respectively.

The first pattern-type static-electricity prevention element 711 may be connected between the first control line LS1 and the second static-electricity prevention unit 800. Further, the second pattern-type static-electricity prevention element 712 may be connected between the second control line LS2 and the second static-electricity prevention unit 800. Further, the third pattern-type static-electricity prevention element 713 may be connected between the third control line LS3 and the second static-electricity prevention unit 800.

The pattern-type static-electricity prevention elements 711, 712, and 713 may each be concurrently (e.g., simultaneously) manufactured along with the pixel transistor TFT of the display panel 105. For example, the first, second, and third pattern-type static-electricity prevention elements 711, 712, and 713 and the pixel transistor TFT may be manufactured through the same photolithography and etching process.

The second static-electricity prevention unit 800 may include at least one mount-type static-electricity prevention element, and in FIG. 3, the second static-electricity prevention unit 800 including a single mount-type static-electricity prevention element 811 is illustrated by way of example.

The mount-type static-electricity prevention element 811 may be connected between the first, second, and third pattern-type static-electricity prevention elements 711, 712, and 713 and ground.

The number of the pattern-type static-electricity prevention elements 711, 712, and 713 may be greater than the number of the mount-type static-electricity prevention element 811.

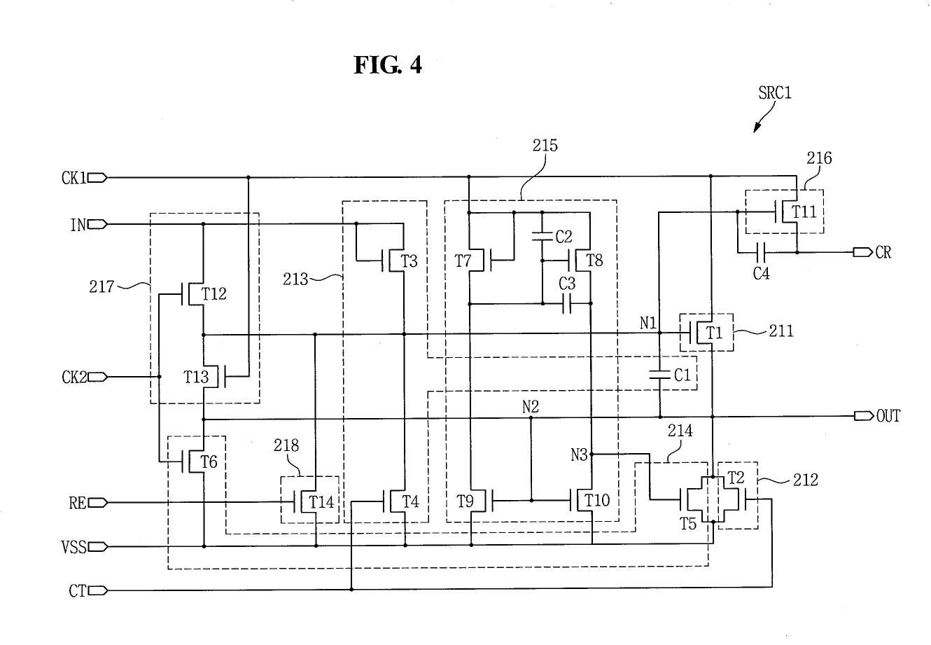

FIG. 4 is a circuit diagram of the first stage SRC1 illustrated in FIG. 3.

The second through (n+1)^{th} stages SRC2-SRCn+1 may have a configuration the same as that of the first stage SRC1. Accordingly, a circuit configuration of the first stage SRC1 will only be described hereinbelow, and a description pertaining to the configuration of the second through (n+1)^{th} stages SRC2-SRCn+1 will be omitted herein for conciseness.

The first stage SRC1, as illustrated in FIG. 4, may include a pull-up unit 211, a pull-down unit 212, a driver 213, a holding unit 214, a switching unit 215, and a carry unit 216. Hereinafter, gate signals output from the first through (n+1)^{th} stages SRC1-SRCn+1 will be defined as first through (n+1)^{th} gate signals.

The pull-up unit 211 may pull up a first clock signal CKV supplied through the first clock terminal CK1, and may output the pulled-up first clock signal CKV through the output terminal OUT as a first gate signal. The pull-up unit 211 may include a first driving transistor T1 connected to a first node N1 through a gate electrode of the first driving transistor T1, connected to the first clock terminal CK1 through a drain electrode thereof, and connected to the output terminal OUT through a source electrode thereof.

The control terminal CT may receive an input of a second gate signal applied thereto, the second gate signal being output through the output terminal OUT of the second stage SRC2. Accordingly, the pull-down unit 212 may pull down the pulled-up first gate signal to a level of an off-voltage VOFF which is supplied through the off-voltage terminal VSS, in response to the second gate signal of the second stage SRC2. The pull-down unit 212 may include a second driving transistor T2 connected to the control terminal CT through a gate electrode of the second driving transistor T2, connected to the output terminal OUT through a drain electrode thereof, and connected to the off-voltage terminal VSS through a source electrode thereof.

The driver 213 may turn on the pull-up unit 211 in response to a vertical start signal STV supplied through the input terminal IN, and may turn off the pull-up unit 211 in response to the second gate signal supplied from the second stage SRC2. For such turn-on and turn-off operations, the driver 213 may include a buffer unit, a charging unit, and a discharging unit.

The buffer unit may include a third driving transistor T3 connected to the input terminal IN through a gate electrode and a drain electrode of the third driving transistor T3 and connected to the first node N1 through a source electrode thereof.

The charging unit may include a first capacitor C1 connected to the first node N1 through a first electrode of the first capacitor C1 and connected to a second node N2 through a second electrode thereof.

The discharging unit may include a fourth driving transistor T4 connected to the control terminal CT through a gate electrode of the fourth driving transistor T4, connected to the first node N1 through a drain electrode thereof, and connected to the off-voltage terminal VSS through a source electrode thereof.

The third driving transistor T3 may be turned on in response to the vertical start signal STV received through the input terminal IN. As a result, the vertical start signal SW may be charged in the first capacitor C1. When an electric charge having a voltage level higher than that of a threshold voltage of the first driving transistor T1 is stored in the first capacitor C1, the first driving transistor T1 may be turned on. The turned-on first driving transistor T1 may output the first clock signal CKV, which is input from the first clock terminal CK1, to the output terminal OUT.

A potential of the first node N1 may be bootstrapped by a variation in a potential of the second node N2 due to a coupling phenomenon of the first capacitor C1 caused by the variation in the potential of the second node N2. Accordingly, the first driving transistor T1 may output the first clock signal CKV applied to the drain electrode thereof to the output terminal OUT, substantially without a loss.

The first clock signal CKV output from the output terminal OUT may be the first gate signal for driving the first gate line GL1. The vertical start signal SW may preparatively charge the first driving transistor T1, so as to generate the first gate signal. Subsequently, the fourth driving transistor T4 may be turned on in response to the second gate signal of the second stage SRC2 input through the control terminal CT. When the fourth driving transistor T4 is turned on, the electric charge stored in the first capacitor C1 may be discharged to the level of the off-voltage VOFF of the off-voltage terminal VSS.

The holding unit 214 may include fifth and sixth driving transistors T5 and T6 that maintain the first gate signal at the level of the off-voltage VOFF. The fifth driving transistor T5 may include a gate electrode connected to the third node N3, a drain electrode connected to the second node N2, and a source electrode connected to the off-voltage terminal VSS. The sixth driving transistor T6 may include a gate electrode connected to the second clock terminal CK2, a drain electrode connected to the second node N2, and a source electrode connected to the off-voltage terminal VSS.

The switching unit 215 may include seventh, eighth, ninth, and tenth driving transistors T7, T8, T9, and T10 and second and third capacitors C2 and C3, and may control driving operation of the holding unit 214.

The seventh driving transistor T7 may include a gate electrode and a drain electrode connected to the first clock terminal CK1 and a source electrode connected to the third node N3 through the third capacitor C3.

The eighth driving transistor T8 may include a drain electrode connected to the first clock terminal CK1, a gate electrode connected to the drain electrode of the eighth driving transistor T8 through the second capacitor C2, and a source electrode connected to the third node N3. In addition, the source electrode of the eighth driving transistor T8 may be connected to the gate electrode of the eighth driving transistor T8 through the third capacitor C3.

The ninth driving transistor T9 may include a drain electrode connected to the source electrode of the seventh driving transistor T7, a gate electrode connected to the second node N2, and a source electrode connected to the off-voltage terminal VSS.

The tenth driving transistor T10 may include a drain electrode connected to the third node N3, a gate electrode connected to the second node N2, and a source electrode connected to the off-voltage terminal VSS.

When a clock signal having a high level is output as a first gate signal through the output terminal OUT, a potential of the second node N2 may rise to a high level. When the potential of the second node N2 rises to the high level, the ninth and tenth driving transistors T9 and T10 may be turned on. In this instance, the seventh and eighth driving transistors T7 and T8 may be turned on by the first clock signal CKV which is input to the first clock terminal CK1. The signals output through the seventh and eighth driving transistors T7 and T8 may be discharged to the level of the off-voltage VOFF through the ninth and tenth driving transistors T9 and T10. Accordingly, while the gate signal having the high level is output, a potential of the third node N3 may be maintained at a low level. As a result, the fifth driving transistor T5 may maintain a turned-off state.

Subsequently, the first gate signal may be discharged through the off-voltage terminal VSS by the second gate signal of the second stage SRC2 which is input from the control terminal CT, and the potential of the second node N2 may drop to a low level. Accordingly, the ninth and tenth driving transistors T9 and T10 may be turned off, and the potential of the third node N3 may rise to a high level by the signal output from the seventh and eighth driving transistors T7 and T8. As the level of the potential of the third node N3 rises, the fifth driving transistor T5 may be turned on, and the potential of the second node N2 may be discharged to the level of the off-voltage VOFF through the fifth driving transistor T5.

In such a state, when the sixth driving transistor T6 is turned on by the second clock signal CKVB which is input to the second clock terminal CK2, the potential of the second node N2 may further be discharged through the off-voltage terminal VSS. As a result, the fifth and sixth driving transistors T5 and T6 of the holding unit 214 may maintain the potential of the second node N2 at the level of the off-voltage VOFF.

The switching unit 215 may determine a turned-on point in time of the fifth driving transistor T5.

The carry unit 216 may include an eleventh driving transistor T11. The eleventh driving transistor T11 may be connected to the first clock terminal CK1 through a drain electrode thereof, connected to the first node N1 through a gate electrode thereof, and connected to the carry terminal CR through a source electrode thereof. In a case of the potential of the first node N1 rising, the eleventh driving transistor T11 may be turned on to output, to the carry terminal CR, the first clock signal CKV which is input to the drain electrode thereof.

The first stage SRC1 may further include a ripple prevention (or reduction) unit 217 and a reset unit 218.

The ripple prevention unit 217 may prevent the first gate signal maintained in a state of the off-voltage VOFF from being distorted by noise (or reduce distortion due to noise) which is input through the input terminal IN. To this end, the ripple prevention unit 217 may include twelfth and thirteenth driving transistors T12 and T13.

The twelfth driving transistor T12 may include a drain electrode connected to the input terminal IN, a gate electrode connected to the second clock terminal CK2, and a source electrode connected to the first node N1.

The thirteenth driving transistor T13 may include a drain electrode connected to the first node N1, a gate electrode connected to the first clock terminal CK1, and a source electrode connected to the second node N2.

The reset unit 218 may include a fourteenth driving transistor T14. The fourteenth driving transistor T14 may be connected to the first node N1 through a drain electrode thereof, connected to the reset terminal RE through a gate electrode thereof, and connected to the off-voltage terminal VSS through a source electrode thereof. The fourteenth driving transistor T14 may discharge the first node N1 to the level of the off-voltage VOFF in response to an (n+1)^{th} gate signal of the (n+1)^{th} stage SRCn+1 which is input through the reset terminal RE. The output of the (n+1)^{th} gate signal from the (n+1)^{th} stage SRCn+1 may indicate an end of a single frame. The reset unit 218 may serve to discharge the first node N1 of the first through (n+1)^{th} stages SRC1-SRCn+1 at a point in time at which the single frame ends. In other words, the fourteenth driving transistor T14 of the reset unit 218 provided in each of the first through (n+1)^{th} stages SRC1-SRCn+1 may be turned on by the output signal of the (n+1)^{th} stage SRCn+1. The turned-on fourteenth driving transistor T14 may reset the first node N1 of each of the first through (n+1)^{th} stages SRC1-SRCn+1 to the state of the off-voltage VOFF. As a result, the first through (n+1)^{th} stages SRC1-SRCn+1 of the shift register 210 may restart operation in an initialized state.

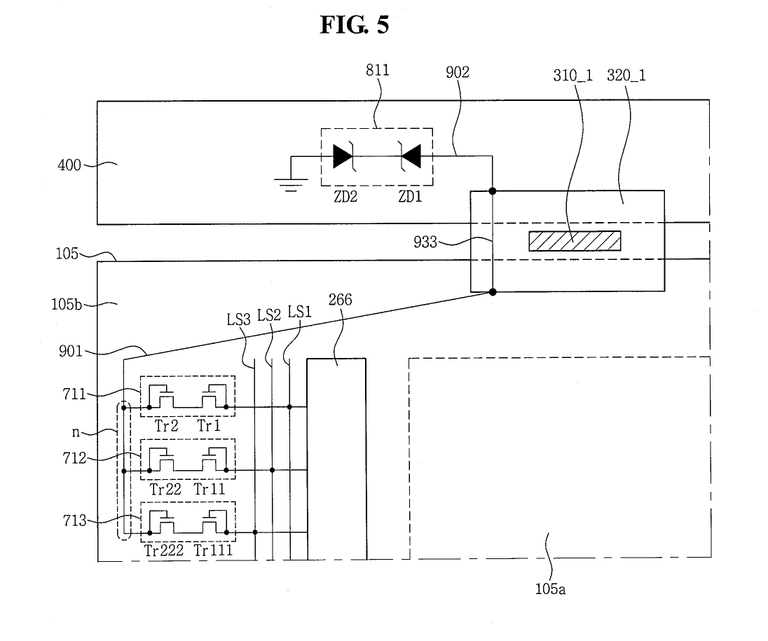

FIG. 5 is a detailed configuration view illustrating an example of the first, second, and third pattern-type static-electricity prevention elements 711, 712, and 713 and the mount-type static-electricity prevention element 811 of FIG. 3.

The first pattern-type static-electricity prevention element 711 may include at least one pattern-type Zener diode, and in FIG. 5, the first pattern-type static-electricity prevention element 711 including two pattern-type Zener diodes Tr1 and Tr2 is illustrated by way of example. Each of the pattern-type Zener diodes Tr1 and Tr2, as illustrated in FIG. 5, may be a transistor having a diode shape. Herein, the two pattern-type Zener diodes are referred to as a first pattern-type Zener diode Tr1 and a second pattern-type Zener diode Tr2, respectively.

The first pattern-type Zener diode Tr1 of the first pattern-type static-electricity prevention element 711 may be connected to the first control line LS1. For example, a gate electrode and a drain electrode of the first pattern-type Zener diode Tr1 may be connected to the first control line LS1.

The second pattern-type Zener diode Tr2 of the first pattern-type static-electricity prevention element 711 may be connected between the first pattern-type Zener diode Tr1 and the mount-type static-electricity prevention element 811. For example, a gate electrode and a drain electrode of the second pattern-type Zener diode Tr2 may be connected to the mount-type static-electricity prevention element 811. Herein, the first pattern-type Zener diode Tr1 and the second pattern-type Zener diode Tr2 may be connected to each other in a reverse manner. For example, a source electrode of the first pattern-type Zener diode Tr1 and a source electrode of the second pattern-type Zener diode Tr2 may be connected to each other.

In addition, the first pattern-type static-electricity prevention element 711 may include only one of the first pattern-type Zener diode Tr1 and the second pattern-type Zener diode Tr2.

The second pattern-type static-electricity prevention element 712 may include at least one pattern-type Zener diode, and in FIG. 5, the second pattern-type static-electricity prevention element 712 including two pattern-type Zener diodes Tr11 and Tr22 is illustrated by way of example. Each of the pattern-type Zener diodes Tr11 and Tr22, as illustrated in FIG. 5, may be a transistor having a diode shape. Herein, the two pattern-type Zener diodes are referred to as a first pattern-type Zener diode Tr11 and a second pattern-type Zener diode Tr22, respectively.

The first pattern-type Zener diode Tr11 of the second pattern-type static-electricity prevention element 712 may be connected to the second control line LS2. For example, a gate electrode and a drain electrode of the first pattern-type Zener diode Tr11 may be connected to the second control line LS2.

The second pattern-type Zener diode Tr22 of the second pattern-type static-electricity prevention element 712 may be connected between the first pattern-type Zener diode Tr11 and the mount-type static-electricity prevention element 811. For example, a gate electrode and a drain electrode of the second pattern-type Zener diode Tr22 may be connected to the mount-type static-electricity prevention element 811. Herein, the first pattern-type Zener diode Tr11 and the second pattern-type Zener diode Tr22 may be connected to each other in a reverse manner. For example, a source electrode of the first pattern-type Zener diode Tr11 and a source electrode of the second pattern-type Zener diode Tr22 may be connected to each other.

In addition, the second pattern-type static-electricity prevention element 712 may include only one of the first pattern-type Zener diode Tr11 and the second pattern-type Zener diode Tr22.

The third pattern-type static-electricity prevention element 713 may include at least one pattern-type Zener diode, and in FIG. 5, the third pattern-type static-electricity prevention element 713 including two pattern-type Zener diodes Tr111 and Tr222 is illustrated by way of example. Each of the pattern-type Zener diodes Tr111 and Tr222, as illustrated in FIG. 5, may be a transistor having a diode shape. Herein, the two pattern-type Zener diodes are referred to as a first pattern-type Zener diode Tr111 and a second pattern-type Zener diode Tr222, respectively.

The first pattern-type Zener diode Tr111 of the third pattern-type static-electricity prevention element 713 may be connected to the third control line LS3. For example, a gate electrode and a drain electrode of the first pattern-type Zener diode Tr111 may be connected to the third control line LS3.

The second pattern-type Zener diode Tr222 of the third pattern-type static-electricity prevention element 713 may be connected between the first pattern-type Zener diode Tr111 and the mount-type static-electricity prevention element 811. For example, a gate electrode and a drain electrode of the second pattern-type Zener diode Tr222 may be connected to the mount-type static-electricity prevention element 811. Herein, the first pattern-type Zener diode Tr111 and the second pattern-type Zener diode Tr222 may be connected to each other in a reverse manner. For example, a source electrode of the first pattern-type Zener diode Tr111 and a source electrode of the second pattern-type Zener diode Tr222 may be connected to each other.

In addition, the third pattern-type static-electricity prevention element 713 may include only one of the first pattern-type Zener diode Tr111 and the second pattern-type Zener diode Tr222.

The mount-type static-electricity element 811 may include at least one Zener diode, and in FIG. 5, the mount-type static-electricity element 811 including two Zener diodes DZ1 and DZ2 is illustrated by way of example. Herein, the two Zener diodes DZ1 and DZ2 will be defined as a first Zener diode ZD1 and a second Zener diode ZD2, respectively.

The first Zener diode ZD1 may be connected to the first, second, and third pattern-type static-electricity prevention elements 711, 712, and 713, in common. For example, an anode electrode of the first Zener diode ZD1 may be connected to the second pattern-type Zener diode Tr2 of the first pattern-type static-electricity prevention element 711, connected to the second pattern-type Zener diode Tr2 of the second pattern-type static-electricity prevention element 712, and connected to the second pattern-type Zener diode Tr2 of the third pattern-type static-electricity prevention element 713.

The mount-type static-electricity prevention element 811 may be a transient voltage suppressor (TVS) diode.

In addition, the mount-type static-electricity prevention element 811 may include only one of the first Zener diode ZD1 and the second Zener diode ZD2.

The first, second, and third pattern-type static-electricity prevention elements 711, 712, and 713 may be connected to the mount-type static-electricity prevention element 811 through a first transmission line 901, a dummy line 933, and a second transmission line 902. Herein, the first transmission line 901 may be disposed in the non-display area 105b of the display panel 105, the dummy line 933 may be disposed on the leftmost carrier 320_1, and the second transmission line 902 may be disposed on the driving circuit board 400. The carriers 320_1-320_k may each include the dummy line 933, and one of the dummy line 933 in the leftmost carrier 320_1, among the carriers 320_1-320_k, may be used to connect the first transmission line 901 and the second transmission line 902.

The first pattern-type static-electricity prevention element 711, the second pattern-type static-electricity prevention element 712, the third pattern-type static-electricity prevention element 713, and the mount-type static-electricity prevention element 811 may be connected to a node n, in common, and the node n may be positioned (or located) in the non-display area 105b of the display panel 105. Accordingly, the first pattern-type static-electricity prevention element 711, the second pattern-type static-electricity prevention element 712, and the third pattern-type static-electricity prevention element 713, and the mount-type static-electricity prevention element 811 may be connected to one another, using the single dummy line 933.

The driving operation of the pattern-type static-electricity prevention elements 711, 712, and 713 and the mount-type static-electricity prevention element 811, which have a configuration illustrated in FIG. 5, will be described hereinbelow.

When the vertical start signal SW having a normal voltage level is applied to the first control line LS1, the first pattern-type static-electricity prevention element 711 may operate as follows.

Firstly, in a case where the vertical start signal SW has a normal high voltage, for example, a voltage less than a Zener voltage of the second pattern-type Zener diode Tr2, due to the high voltage, the first pattern-type Zener diode Tr1 is forward-biased, while the second pattern-type Zener diode Tr2 is reverse-biased. Accordingly, the first pattern-type Zener diode Tr1 is turned on, while the second pattern-type Zener diode Tr2 is turned off. As a result, when the vertical start signal STV has a normal high voltage, the first pattern-type static-electricity prevention element 711 and the first control line LS1 may be electrically separated (or electrically disconnected) from each other, and thus the vertical start signal SW may be output in a normal manner.

Secondly, in a case where the vertical start signal SW has a normal low voltage, for example, a voltage less than a Zener voltage of the first pattern-type Zener diode Tr1, due to the low voltage, the first pattern-type Zener diode Tr1 is reverse-biased. Accordingly, the first pattern-type Zener diode Tr1 is turned off. As a result, when the vertical start signal SW has a normal low voltage, the first pattern-type static-electricity prevention element 711 and the first control line LS1 may be electrically separated (or electrically disconnected) from each other, and thus the vertical start signal SW may be output in a normal manner.

In addition, in a case where static electricity flows to the first control line LS1 for the vertical start signal SW to have an abnormally high voltage or an abnormally low voltage, the first pattern-type static-electricity prevention element 711 and the mount-type static-electricity prevention element 811 may operate as follows.

Firstly, in a case where the vertical start signal SW has an abnormally high voltage, for example, a voltage higher than a Zener voltage of the second pattern-type Zener diode Tr2, due to the high voltage, the first pattern-type Zener diode Tr1 is forward-biased, while the second pattern-type Zener diode Tr2 is reverse-biased. In this case, the second pattern-type Zener diode Tr2 may cause a Zener phenomenon. Accordingly, the first pattern-type Zener diode Tr1 and the second pattern-type Zener diode Tr2 may both be turned on. In addition, a voltage (hereinafter, “subtraction voltage”), which is obtained by subtracting a voltage across both ends of the first pattern-type static-electricity prevention element 711 from the abnormally high voltage, may be applied to the mount-type static-electricity prevention element 811. In a case where the subtraction voltage is higher than a Zener voltage of the second Zener diode ZD2, due to the subtraction voltage, the first Zener diode ZD1 is forward-biased and the second Zener diode ZD2 is reverse-biased. In this case, the second Zener diode ZD2 may cause a Zener phenomenon. Accordingly, the first Zener diode ZD1 and the second Zener diode ZD2 may both be turned on. As a result, when the vertical start signal STV has an abnormally high voltage due to the static electricity having flown to the first control line LS1, a large current induced by the vertical start signal STV having an abnormally high voltage level may flow into ground through the first pattern-type static-electricity prevention element 711 and the mount-type static-electricity prevention element 811. Accordingly, the large current induced by the static electricity may be prevented from flowing to the gate driver 266.

Secondly, in a case where the vertical start signal SW has an abnormally low voltage, for example, a voltage lower than a Zener voltage of the first pattern-type Zener diode Tr1, due to the low voltage, the first pattern-type Zener diode Tr1 is reverse-biased and the second pattern-type Zener diode Tr2 is forward-biased. In this case, the first pattern-type Zener diode Tr1 may cause a Zener phenomenon. Accordingly, the first pattern-type Zener diode Tr1 and the second pattern-type Zener diode Tr2 may both be turned on. In addition, a voltage (hereinafter, “subtraction voltage”), which is obtained by subtracting a voltage across both ends of the first pattern-type static-electricity prevention element 711 from the abnormally low voltage, may be applied to the mount-type static-electricity prevention element 811. In a case where the subtraction voltage is lower than a Zener voltage of the first Zener diode ZD1, due to the subtraction voltage, the first Zener diode ZD1 is reverse-biased and the second Zener diode ZD2 is forward-biased. In this case, the first Zener diode ZD1 may cause a Zener phenomenon. Accordingly, the first Zener diode ZD1 and the second Zener diode ZD2 may both be turned on. As a result, when the vertical start signal STV has an abnormally low voltage due to the static electricity having flown to the first control line LS1, a large current induced by the vertical start signal STV having an abnormal voltage level may flow into ground through the first pattern-type static-electricity prevention element 711 and the mount-type static-electricity prevention element 811. Accordingly, the large current induced by the static electricity may be prevented from flowing to the gate driver 266.

The other pattern-type static electricity prevention units (e.g., second and third pattern-type static-electricity prevention units 712 and 713) may operate in the same manner as the aforementioned first pattern-type static-electricity prevention element 711 operates.

The price (or manufacturing cost) of the pattern-type static electricity prevention unit, for example, one of the pattern-type static-electricity prevention elements 711, 712, and 713, is lower than the price (or manufacturing cost) of the mount-type static-electricity prevention element 811. However, the performance of discharging static electricity in the mount-type static-electricity prevention element 811 is excellent, compared to that in one of the pattern-type static-electricity prevention elements 711, 712, and 713. In reference to FIG. 5, the pattern-type static-electricity prevention elements 711, 712, and 713 may be provided in plural inside the display panel 105, and the mount-type static-electricity prevention element 811 may be provided, outside the display panel 105, to be less than the pattern-type static-electricity prevention elements 711, 712, and 713 in number. As a result, an excellent static-electricity discharging performance may be achieved at little (or low) cost.

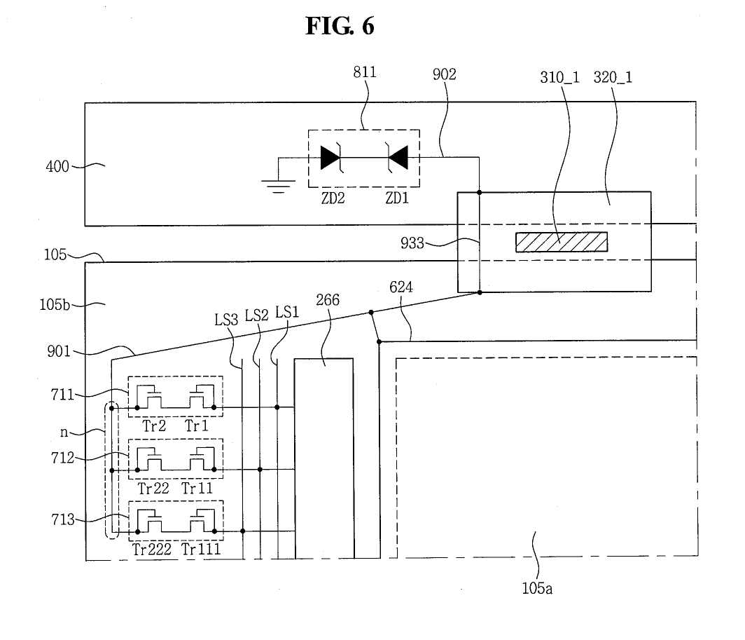

FIG. 6 is a detailed configuration view illustrating another example of first, second, and third pattern-type static-electricity prevention elements 711, 712, and 713 and a mount-type static-electricity prevention element 811 of FIG. 3.

As illustrated in FIG. 6, the display panel 105 may further include a common line 624 which transmits the common voltage. The common line 624 may have a closed-loop shape enclosing (e.g., surrounding) the display area 105a. Alternatively, the common line 624 may be discontinuously disposed around the non-display area 105b, and thus may not intersect or cross the gate lines GL1-GLn and the data lines DL1-DLm.

The common line 624 may be connected to the common electrode 130 disposed on an upper substrate of the display panel 105. The common line 624 and the common electrode 130 may be connected to each other through a dot electrode. The dot electrode may be disposed between the common line 624 and the common electrode 130. The dot electrode may be formed of gold (Ag), which has excellent electrical conductivity characteristics.

The node n between the pattern-type static-electricity prevention elements 711, 712, and 713 and the mount-type static-electricity prevention element 811 may be connected to the common line 624. For example, as illustrated in FIG. 6, the first transmission line 901 may be connected to the common line 624.

In addition, the node n between the pattern-type static-electricity prevention elements 711, 712, and 713 and the mount-type static-electricity prevention element 811 may be connected to a storage voltage line which transmits a storage voltage, rather than being connected to the common line 624. The storage voltage line may be disposed along a side of a pixel electrode. The storage voltage line may form a storage capacitor Cst, along with the pixel electrode. In this regard, the storage voltage line may overlap the pixel electrode.

In addition, the node n between the pattern-type static-electricity prevention elements 711, 712, and 713 and the mount-type static-electricity prevention element 811 may be connected to the off-voltage line VSSL, rather than being connected to the common line 624.

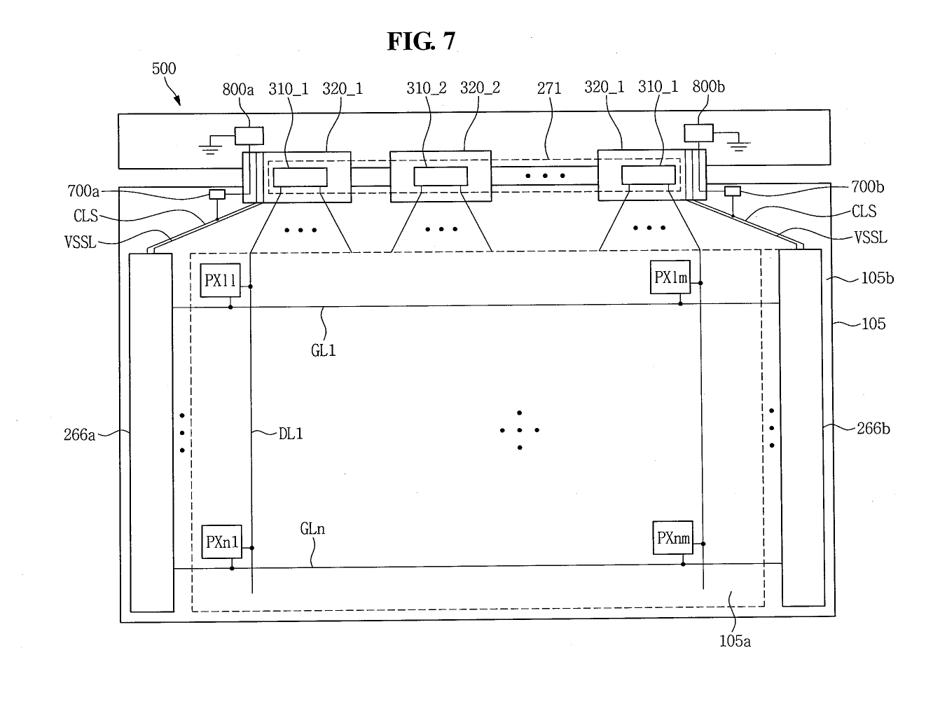

FIG. 7 is a plan view illustrating a display device according to another exemplary embodiment.

As illustrated in FIG. 7, the display device according to another exemplary embodiment, as compared to the display device illustrated in FIG. 1, may further include a second gate driver 266b, a third static-electricity prevention unit 700b, and a fourth static-electricity prevention unit 800b.

Gate lines provided in the display device illustrated in FIG. 7 may be operated by a first gate driver 266a and the second gate driver 266b. The gate lines may each receive a gate signal applied thereto from the first gate driver 266a and a gate signal applied thereto from the second gate driver 266b concurrently (e.g., at the same time). The first gate driver 266a and the second gate driver 266b may have the same configuration as that of the gate driver 266 illustrated in FIG. 1.

The first static-electricity prevention unit 700a and the second static-electricity prevention unit 800a may be substantially identical to the first static-electricity prevention unit 700 and the second static-electricity prevention unit 800 illustrated in FIG. 1.

The third static-electricity prevention unit 700b and the fourth static-electricity prevention unit 800b may be substantially identical to the first static-electricity prevention unit 700 and the second static-electricity prevention unit 800 illustrated in FIG. 1. However, the third static-electricity prevention unit 700b and the fourth static-electricity prevention unit 800b may be connected to each other through a rightmost carrier 320_k.

As set forth above, a display device according to embodiments of the present invention may provide the following effects.

The display device according to the present invention includes a static-electricity prevention unit which may outwardly discharge static electricity that flows into a control line. Accordingly, a pixel transistor, a gate driver, and the like may be prevented from being damaged.

Further, according to aspects of the present invention, a great number of pattern-type static-electricity prevention elements, which exhibit a less efficiency in discharging static electricity while being provided at a relatively low cost, are disposed inside a panel, and a mount-type static-electricity prevention element, which exhibits an excellent efficiency in discharging static electricity while being provided at a relatively high cost, is provided outside a panel. Further, the plurality of pattern-type static-electricity prevention elements and the mount-type static-electricity prevention element are connected to one another. Accordingly, the display device may achieve excellent performance in discharging static electricity at a relatively low cost.

From the foregoing, it will be appreciated that various embodiments in accordance with the present disclosure have been described herein for purposes of illustration, and that various modifications may be made without departing from the scope and spirit of the present teachings. Accordingly, the various embodiments disclosed herein are not intended to be limiting of the true scope and spirit of the present teachings. Various features of the above described and other embodiments can be mixed and matched in any manner, to produce further embodiments consistent with the invention.

What is claimed is:

1. A display device comprising:
a gate driver configured to drive a plurality of gate lines of a display panel;
at least one control line configured to transmit at least one control signal to the gate driver;
a first static-electricity prevention unit on the display panel, the first static-electricity prevention unit being connected to the at least one control line; and
a second static-electricity prevention unit outside the display panel, the second static-electricity prevention unit connected between the first static-electricity prevention unit and ground.

2. The display device of claim 1, wherein the first static-electricity prevention unit comprises at least one pattern-type static-electricity prevention element connected to the at least one control line, and
wherein the second static-electricity prevention unit comprises at least one mount-type static-electricity prevention element connected between the at least one pattern-type static-electricity prevention element and ground.

3. The display device of claim 2, wherein the number of the pattern-type static-electricity prevention elements is greater than the number of mount-type static-electricity prevention elements.

4. The display device of claim 2, wherein the pattern-type static-electricity prevention element comprises:
a first pattern-type Zener diode connected to the control line; and
a second pattern-type Zener diode connected between the first pattern-type Zener diode and the second static-electricity prevention unit.

5. The display device of claim 4, wherein each of the first pattern-type Zener diode and the second pattern-type Zener diode is a transistor having a shape of diode.

6. The display device of claim 5, wherein the first pattern-type Zener diode and the second pattern-type Zener diode are connected to each other in a reverse manner.

7. The display device of claim 2, wherein the mount-type static-electricity prevention element comprises:
a first Zener diode connected to the first static-electricity prevention unit; and
a second Zener diode connected between the first Zener diode and ground.

8. The display device of claim 7, wherein the first Zener diode and the second Zener diode are connected to each other in a reverse manner.

9. The display device of claim 1, wherein the first static-electricity prevention unit is formed concurrently with a pixel transistor of the display panel.

10. The display device of claim 1, further comprising a circuit board connected to the display panel, the second static-electricity prevention unit being located on the circuit board.

11. The display device of claim 10, wherein the second static-electricity prevention unit is detachably connected to the circuit board.

12. The display device of claim 10, further comprising a carrier connected between the circuit board and the display panel and connecting the first static-electricity prevention unit and the second static-electricity prevention unit.

13. The display device of claim 1, further comprising a common voltage line connected to a node between the first static-electricity prevention unit and the second static-electricity prevention unit.

14. The display device of claim 13, wherein the common voltage line is located on the display panel and connected to a common electrode of the display panel.

15. The display device of claim 1, further comprising a storage voltage line connected to the node between the first static-electricity prevention unit and the second static-electricity prevention unit.

16. The display device of claim 15, wherein the storage voltage line is located along a side of the pixel electrode of the display panel.

17. The display device of claim 1, further comprising an off-voltage line connected to the node between the first static-electricity prevention unit and the second static-electricity prevention unit.

18. The display device of claim 17, wherein the off-voltage line is configured to apply an off voltage to the gate driver.

19. The display device of claim 1, wherein the node between the first static-electricity prevention unit and the second static-electricity prevention unit is located on the display panel.
